(19) United States
(12) Patent Application Publication
(10) Pub. No.: US 2006/0192665 A1
(43) Pub. Date: Aug. 31, 2006

(54) System for improving the visibility of a vehicle during reduced visibility conditions

(76) Inventor: Won Moo Song, Haltom City, TX (US)

Correspondence Address: CARSTENS & CAHOON, LLP, P O BOX 802334, DALLAS, TX, 75380, US

(21) Appl. No.: 11/057,970

(22) Filed: Feb. 15, 2005

(51) Int. Cl. B60Q 1/26

(52) U.S. Cl. 340/469

(57) ABSTRACT

Improved proximity indicators and turn indicators for hazardous operating conditions. Such indicators provide increased visibility and safety to observers and operators of vehicles. Such lights may be comprised of separate devices or may be comprised of flashing or strobing brake, accelerator, and/or turn indicators positioned at the front, sides, top, and rear of a vehicle. The intensity and flashing pattern of such indicators vary according to the operating settings of a vehicle, the proximity of obstacles including other vehicles, the desire of the operator, and according to the prevailing operating or weather conditions.

### DETAILED DESCRIPTION OF THE INVENTION

The present invention relates to a novel system for improving the visibility of a vehicle in reduced visibility conditions. A first vehicle is equipped with the means for flashing its lights based on a driver's manual input or any number of sensors that will be discussed below. The flashing can be made more effective by altering its rate or its intensity or by flashing the lights in a particular sequence. The driver can also be kept informed with a monitor that shows the status of the flashing. Various sensors can be used to trigger the flashing. The flashing makes the first vehicle more conspicuous to a second vehicle.

In one embodiment, the lights or indicators are of at least two colors. One color can be for accelerator indicators, and the other for brake indicators. For example, the accelerator indicator could be green, while the brake indicator could be red. In one embodiment, the colored light is emitted directly from the light source. In another embodiment, the colored light is generated by a lens covering the light source. Such indicators provide improved safety or warning lights, especially in hazardous or inclement weather.

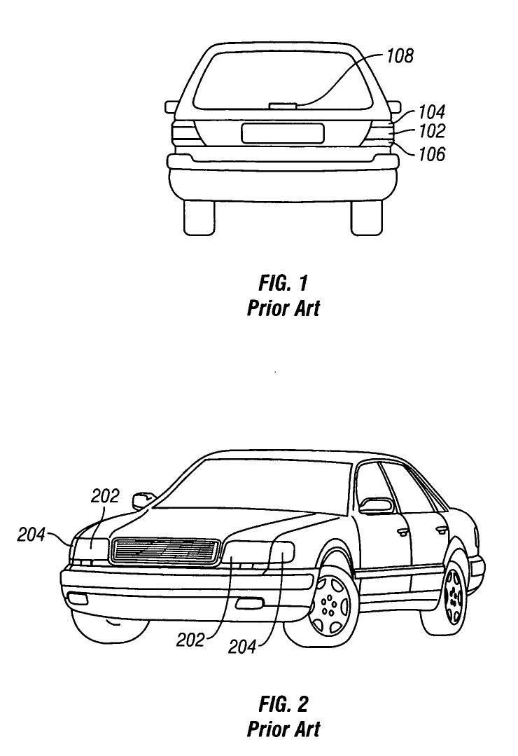

As shown in FIGS. 1 and 2, a car is already equipped with a variety of lights: headlights, brake lights, turn indicator lights, reverse indicator lights, and so forth. These can be located in a variety of locations on the vehicle, including the front, rear and sides. Such accelerator and brake indicators may be illuminated in a variety of intensities including, but not limited to, low, medium and high intensity states, or lower, equal and higher states relative to running lights, emergency lights, conventional brake lights, or headlights. The states of such indicators may be of any intensity, duration, or pattern.

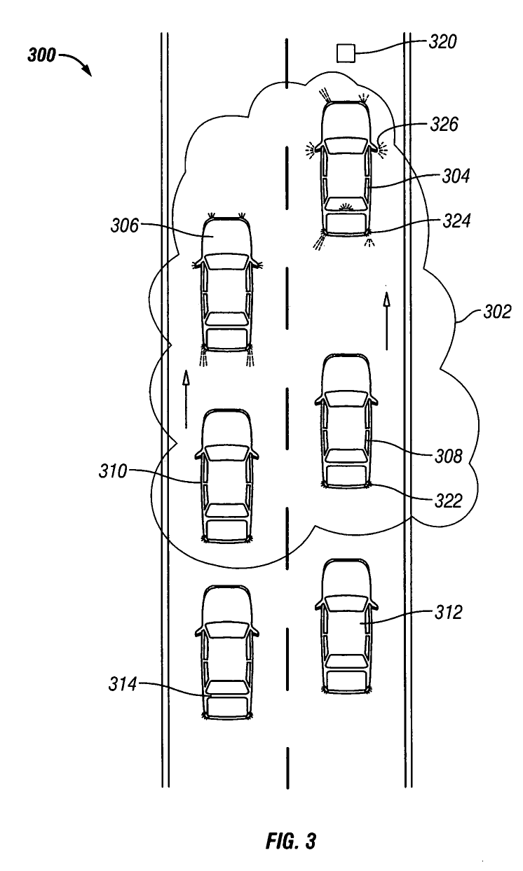

FIG. 3 illustrates a number of cars that are traveling on a road. Visibility is partially obscured by fog 302. The fog will make it difficult under normal circumstances for vehicle 308 to see that vehicle 304 is braking hard to avoid an object 320. Even if the driver of vehicle 308 sees red lights ahead of him, he may not be able to easily distinguish between normal running light intensity and brake light intensity. This is why fog and other reduced visibility situations are responsible for so many traffic accidents and fatalities. However, if the first vehicle 304 had flashing brake lights 424, it is far more likely that the second vehicle 308 would recognize that it also needed to brake to avoid a collision. A trailing car 308 in the fog is not the only vehicle that would benefit from a more conspicuous warning. Car 312 will benefit if second vehicle 308 also has flashing brake lights 322. Likewise, vehicle 306 would benefit from the flashing of side mounted lights 326.

Several tables will help to illustrate several of the embodiments that implement this inventive system:

TABLE 1
Embodiment #1

| | | | | Accelerator |
|---|---|---|---|---|
| Brake | Accelerator | Status | Brake lights | lights |
| Disengaged | Disengaged | Coasting | Flashing | Flashing |
| Engaged | Disengaged | Braking | Flashing | Not flashing |
| Disengaged | Engaged | Accelerating | Not flashing | Flashing |

So, in this first embodiment, all the lights are programmed to flash while the car is coasting. Only brake lights are programmed to flash during braking and only the accelerator lights are programmed to flash during acceleration.

TABLE 2
Embodiment #2

| | | | | Accelerator |
|---|---|---|---|---|
| Brake | Accelerator | Status | Brake lights | lights |
| Disengaged | Disengaged | Coasting | Flashing | Not Flashing |
| Engaged | Disengaged | Braking | Flashing | Not flashing |
| Disengaged | Engaged | Accelerating | Not flashing | Flashing |

So, in this second embodiment, only the brake lights are programmed to flash while the car is coasting. Only brake lights are programmed to flash during braking and only the accelerator lights are programmed to flash during acceleration.

TABLE 3
Embodiment #3

| | | | | Accelerator |
|---|---|---|---|---|
| Brake | Accelerator | Status | Brake lights | lights |
| Disengaged | Disengaged | Coasting | Not Flashing | Flashing |
| Engaged | Disengaged | Braking | Flashing | Not flashing |
| Disengaged | Engaged | Accelerating | Not flashing | Flashing |

So, in this first embodiment, only the accelerator lights are programmed to flash while the car is coasting. Only brake lights are programmed to flash during braking and only the accelerator lights are programmed to flash during acceleration.

In addition to these three embodiments, the system can also be utilized to improve the visibility of turn indicators.

TABLE 4
Turn Signals

| | Embodiment #1 | Embodiment #2 | Embodiment #3 |
|---|---|---|---|
| | Right signal/ | Right signal/ | Right signal/ |
| Direction | left signal | Left signal | Left signal |
| Right turn | 3x/1x | 1x/0x | Both, then right only |
| Left turn | 1x/3x | 0x/1x | Both, then left only |

In other words, in one embodiment one signal flashes some multiple times faster than the other signal. In a second embodiment, only one signal flashes. In a third embodiment, turn indicators located on both sides of the vehicle can be flashed, followed by the flashing of the turn indicator for the direction of the turn

As mentioned above, the brake or accelerator or a third light can be used for as turning lights. These lights can be red, green, amber or any other color. For purposes of the charts below the mark * means a single flash to multiple flashing and *** means multiple flashing to multi times plus multi times.

Accelerator Light Used as Turn Signal

| Status | Indicators | Brake lights | Accelerator lights |
|---|---|---|---|
| Emergency | Right indicators | *** *** *** | *** *** *** |
| | Left indicators | *** *** *** | *** *** *** |
| Coasting | Right indicators | | * * * * * * |
| | Left indicators | | * * * * * * |
| Coasting & | Right indicators | | *** *** *** |
| Right turn | Left indicators | | * * * * * * |
| Coasting & | Right indicators | | * * * * * * |
| Left turn | Left indicators | | *** *** *** |
| Braking | Right indicators | * * * * * * | |
| | Left indicators | * * * * * * | |
| Braking & | Right indicators | * * * * * * | *** *** *** |
| Right turn | Left indicators | * * * * * * | |
| Braking & | Right indicators | * * * * * * | |
| Left turn | Left indicators | * * * * * * | *** *** *** |
| Sudden Stop or | Right indicators | *** *** *** * * * * | |
| Full Stop | Left indicators | *** *** *** * * * * | |
| Sudden braking & Right turn or Full | Right indicators | *** *** *** * * * * | *** *** *** *** *** |
| Stopping & Right turn | Left indicators | *** *** *** * * * * | |
| Sudden braking | Right indicators | *** *** *** * * * * | |
| & Left turn or Full Stopping & Left turn | Left indicators | *** *** *** * * * * | *** *** *** *** *** |
| Accelerating | Right indicators | | * * * * * |
| | Left indicators | | * * * * * |
| Accelerating & Right turn | Right indicators | | *** *** *** |
| | Left indicators | | * * * * * |
| Accelerating & Left turn | Right indicators | | * * * * * |
| | Left indicators | | *** *** *** |

Brake Light Used as Turn Signal

| Status | Indicators | Brake lights | Accelerator lights |
|---|---|---|---|
| Emergency | Right indicators | *** *** *** | *** *** *** |
| | Left indicators | *** *** *** | *** *** *** |
| Coasting | Right indicators | | * * * * * * |
| | Left indicators | | * * * * * * |
| Coasting & Right turn | Right indicators | *** *** *** | * * * * * * |
| | Left indicators | | * * * * * * |
| Coasting & Left turn | Right indicators | | * * * * * * |
| | Left indicators | *** *** *** | * * * * * * |
| Braking | Right indicators | * * * * * * | |
| | Left indicators | * * * * * * | |
| Braking & Right turn | Right indicators | *** *** *** | |
| | Left indicators | * * * * * * | |
| Braking & Left turn | Right indicators | * * * * * * | |
| | Left indicators | *** *** *** | |
| Sudden Braking or Full | Right indicators | *** *** *** * * * * | |
| Stop | Left indicators | *** *** *** * * * * | |
| Sudden Braking & Right turn or Full | Right indicators | *** *** *** *** *** *** | |
| Stopping & Right turn | Left indicators | *** *** *** * * * * | |
| Sudden Braking | Right indicators | *** *** *** * * * * | |
| & Left turn or Full Stopping& Left turn | Left indicators | *** *** *** *** *** *** | |
| Accelerating | Right indicators | | * * * * * * |
| | Left indicators | | * * * * * * |
| Accelerating | Right indicators | *** *** *** | * * * * * * |
| & Right turn | Left indicators | | * * * * * * |
| Accelerating | Right indicators | | * * * * * * |
| & Left turn | Left indicators | *** *** *** | * * * * * * |

III. Case 3. Turn Light Used as Turn Light (Turn lights = Amber or other color)

| Status | Indicators | Brake lights | Accelerator lights | Turn lights |
|---|---|---|---|---|
| Emergency I | Right indicators | *** *** *** | *** *** *** | |
| | Right turn | | | |
| | Left indicators | *** *** *** | *** *** *** | |
| | Right turn | | | |
| Emergency II | Right indicators | *** *** *** | *** *** *** | |
| | Right turn | | | *** *** *** |
| | Left indicators | *** *** *** | *** *** *** | |
| | Right turn | | | *** *** *** |
| Coasting | Right indicators | | * * * * * | |
| | Right turn | | | |
| | Left indicators | | * * * * * | |
| | Right turn | | | |
| Coasting & | Right indicators | | * * * * * | |
| Right turn | Right turn | | | *** *** *** |
| | Left indicators | | * * * * * | |
| | Left turn | | | |
| Coasting & | Right indicators | | * * * * * | |
| Left turn | Right turn | | | |
| | Left indicators | | * * * * * | |
| | Left turn | | | *** *** *** |
| Braking | Right indicators | * * * * * | | |
| | Right turn | | | |
| | Left indicators | * * * * * | | |
| | Right turn | | | |
| Braking & | Right indicators | * * * * * | | |
| Right turn | Right turn | | | *** *** *** |
| | Left indicators | * * * * * | | |
| | Left turn | | | |
| Braking & | Right indicators | * * * * * | | |
| Left turn | Right turn | | | |
| | Left indicators | * * * * * | | |
| | Left turn | | | *** *** *** |
| Sudden | Right indicators | *** *** *** * * * * | | |
| Braking or | Right turn | | | |
| Full Stop | Left indicators | *** *** *** * * * * | | |
| Braking or | Right turn | | | |
| Full Stop | Left indicators | *** *** *** * * * * | | |
| | Right turn | | | |
| Sudden Braking & | Right indicators | *** *** *** * * * * | | |
| Right turn | Right turn | | | *** *** *** *** *** |
| or Full Stop & | Left indicators | *** *** *** * * * * | | |
| Right turn | Left turn | | | |
| Sudden Braking & | Right indicators | *** *** *** * * * * | | |
| Left turn | Right turn | | | |
| or Full Stop & | Left indicators | *** *** *** * * * * | | |
| Left turn | Left turn | | | *** *** *** *** *** |
| Accelerating | Right indicators | | * * * * | |
| | Right turn | | | |
| | Left indicators | | * * * * | |
| | Right turn | | | |
| Accelerating & | Right indicators | | * * * * | |
| Right turn | Right turn | | | *** *** *** |
| | Left indicators | | * * * * | |
| | Left turn | | | |
| Accelerating & | Right indicators | | * * * * | |
| Left turn | Right turn | | | |
| | Left indicators | | * * * * | |
| | Left turn | | | *** *** *** |

Now that the use of flashing for braking, accelerating, coasting, and turning has been discussed, it is important to understand the methods of enhancing the flashing to improve visibility further: with intensity, rate, and with pattern. The intensity of the flash can be varied during the duration of the flashing. For example, the intensity pattern can be bright, medium, medium, or the pattern could be constant. The rate can increase based on the speed of the vehicle. For example, if a car is traveling, then the speed of the flashing could also be increased to provide that information to another driver. Finally, a pattern can be used to increase the conspicuousness of the flashing. The pattern could be evenly spaced, unevenly spaced or random.

The use of flashing lights can be manually controlled or controlled through an automatic control system based on inputs from various sensors. In one embodiment, a moisture, temperature or other type of sensor is used to determine hazardous, low visibility or inclement weather conditions. Such sensor is electrically connected to an electronic logic component which controls the amount of flashing of all indicators. The logic component may be set so as to increase or decrease the intensity of the indicators depending on the prevailing operating conditions such as fog or rain. In a further embodiment, a manual switch is also provided to the vehicle operator to select the amount of flashing of all indicators and the intensity of the illuminated indicators. Such flashing of accelerator and brake indicators may be in addition to the use of traditional turn indicators, or may be used in place of traditional turn indicators in inclement weather because of the benefit of increased visibility under such conditions.

In another embodiment, the flashing of a vehicle's accelerator and brake indicators depends upon the state of a vehicle's gears or gear switch. For example, when a vehicle is in park, a vehicle's accelerator indicators no longer respond to use of the vehicle's accelerator, and brake indicators are dimly or brightly lit. In another example, when a vehicle is in reverse, a vehicle's accelerator indicators are dimly lit, or brightly lit. In a further example, when a vehicle is in reverse, a vehicle's brake indicators are dimly lit, or brightly lit. In another example, an accelerator indicator is illuminated at one level while the vehicle is in one gear and illuminated at a second level while the vehicle is in another gear.

Separate dashboard indicators communicate to a vehicle operator of the state or use of improved brake and accelerator indicators. In one embodiment, on the console or dashboard of a vehicle having an improved accelerator indicator, there is an indicator showing the use of such one or more external accelerator indicators. Further, there is optionally an indicator showing the use of one or more brake indicators. Alternatively, such console indicator shows the actual state of an external accelerator indicator. Also, such console indicator may also show the actual state of an external brake indicator. A console indicator may be used to show the states of accelerator engagement, accelerator disengagement, brake disengagement, brake engagement, and turn signal use.

In one embodiment, a rearward-facing and/or forward-facing proximity detector is used to illuminate or flash indicators and/or sound a horn to warn an approaching vehicle. The indicators may be visible from a rear-facing direction and/or from a forward-facing direction. Such indicators operate automatically or independently of the operator of the vehicle. For example, even if the weather conditions are good, it is important that a vehicle's visibility be increased if a collision is probable. For example, if a driver is falling asleep and his speed will cause an impact with another vehicle, then the lights of the vehicle may be altered in intensity, pace or sequence to warn the forward vehicle. The trailing vehicle may also be warned by actuating the brake lights even if the brakes are not engaged.

In another embodiment, a digital or analog device presents the distance between an object, such as another vehicle, and the front of the operating vehicle. The operator of the vehicle is then more informed as to the actual distance between the vehicle and the object. Such a distance measuring device is more accurate and provides more safety than the operator relying solely on visibility with the naked eye and mental estimation of the distance. Such increased accuracy and safety is especially important under inclement operating conditions such as, but not limited to, fog.

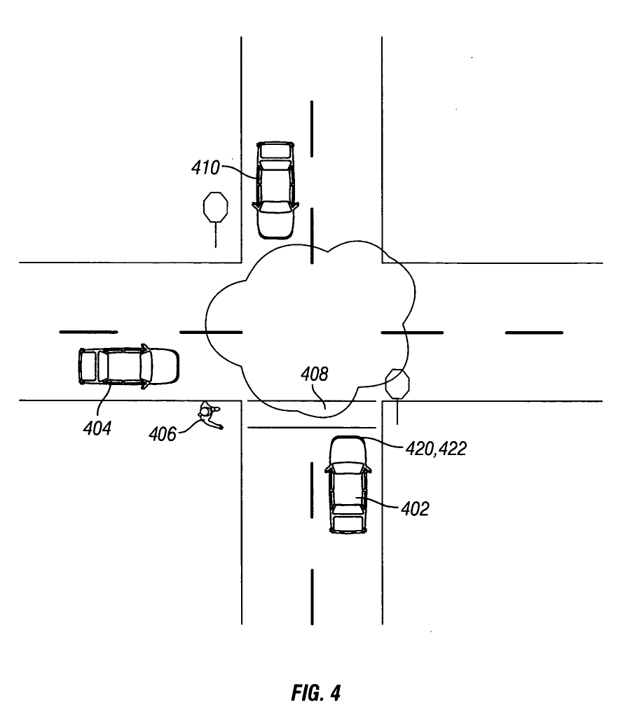

FIG. 4 provides a top view of several cars convening at an intersection wherein there is reduced visibility due to fog 408. A first car 402 approaches a stop sign and prepares to yield. It is urgent that the first car 402 or third car 410 be aware of oncoming second car 404. It is also urgent for a pedestrian 406 to appreciate the danger of entering the intersection. The use of pulsing or flashing lights 420, 422 in accordance with the present invention would improve the safety of the entire situation. The lights could be mounted on the sides, top, front and/or rear of the cars.

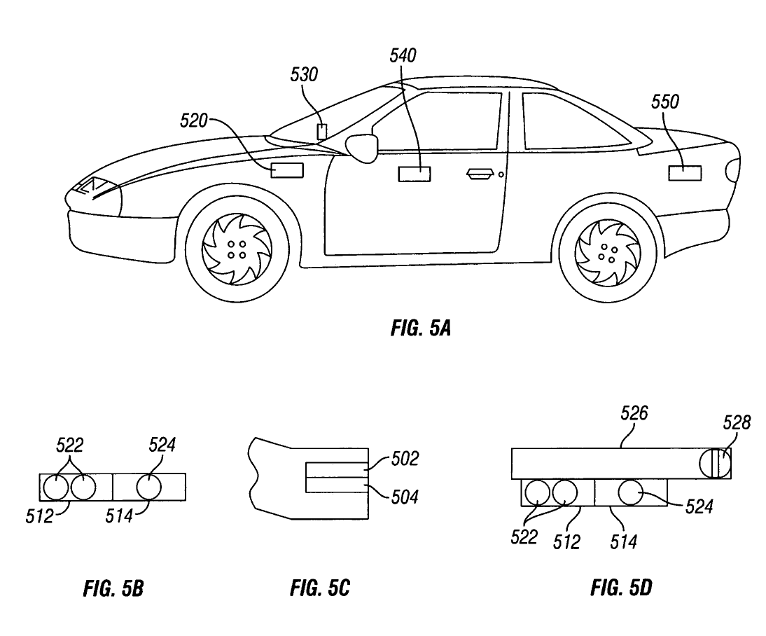

FIG. 5a shows a side view of a vehicle. With reference to FIG. 5a, accelerator and brake indicators may be mounted on the side region near the front region 520 of a vehicle, on the side mounted rearview mirror 530, on or near the door handle 540, or on the rear region 550 of a vehicle. Such indicators are comprised of a housing, at least one light bulb or other light emitting element, at least one socket, and are connected electrically to the electric system of the vehicle. Side, forward and rear accelerator indicators may be of any color.

With reference to FIG. 5b, an indicator unit 520 is comprised of an accelerator indicator 512 and a brake indicator 514. An accelerator indicator 512 may be comprised of two light elements 522 which are capable of providing two or more stages of lighting such as a dim lighting state and a bright lighting state. In such an embodiment, one bulb or lighting element 522 is lit when the accelerator is engaged and the other element 522 is lit when the accelerator is not engaged. Alternatively, one single bulb or element may be manufactured so as to be emit light in varying states of intensity. In an alternative embodiment, one element 522 is lit when the accelerator is engaged and both elements 522 are lit when the accelerator is disengaged. A brake element 524 is lit when the brake is engaged, and is not lit when the brake is disengaged.

Likewise, with reference to FIG. 5d, an indicator unit 540 is comprised as in FIG. 5a but is located near, or is part of, a door handle unit. In such an embodiment, a door handle 526, a key lock 528, an accelerator indicator 512, and a brake indicator 514 comprise a door handle indicator unit. Such unit may have additional indicator functionality such as, but not limited to, illuminating or flashing one or more times upon receiving a signal from a keyless entry device, or illuminating or flashing continuously in a particular pattern upon receiving a signal from an auto theft detection component of the vehicle. Further, a door handle indicator unit may be illuminated continuously to facilitate entry into a vehicle.

In a similar embodiment, and with reference to FIG. 5b, a side indicator unit 530 is mounted to, and forms part of, a side mounted rearview mirror. Such a unit is comprised of an accelerator indicator 502 and a brake indicator 504. Such a unit may have additional functionality such as, but not limited to, illuminating or flashing as a turn signal. In one embodiment, both an accelerator indicator 502 and a brake indicator 504 form a turn indicator, and illuminate or flash brightly upon an action taken by a vehicle driver indicating that the vehicle driver is turning in a particular direction. An accelerator indicator, as part of such a side indicator unit 530, may have a dimly lit state and a brightly lit state as described previously. Such turn indicator may be comprised of any number of colors, and may flash or illuminate in a variety of different patterns or modalities indicating a turn.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternate embodiments to the extent permitted.

I claim:

1. An improved visibility system comprising:
(a) an input for indicating a reduced visibility condition; and
(b) means for flashing at least one indicator light in response to the input.

2. The system of claim 1 wherein said input is a manual switch.

3. The system of claim 1 wherein said input is a distance indicator.

4. The system of claim 1 wherein said input is a speed indicator.

5. The system of claim 1 wherein said input is a light indicator.

6. The system of claim 1 wherein said flashing means comprises means to alter the flashing intensity.

7. The system of claim 1 wherein said flashing means comprises means to alter the flashing rate.

8. The system of claim 1 wherein said flashing means comprises means to alter the flashing pattern.

9. The system of claim 6 wherein said flashing intensity is constant.

10. The system of claim 7 wherein said flashing rate increases with a vehicle's speed.

11. The system of claim 1 wherein said flashing rate decreases with a vehicle's speed.

12. The system of claim 8 wherein the flashing pattern is evenly timed.

13. The system of claim 8 wherein the flashing pattern is random.

14. The system of claim 1 further comprises means to sound a horn to supplement the flashing indicators.

15. The system of claim 1 wherein the indicator light is a brake light.

16. The system of claim 1 wherein the indicator light is an accelerator light.

17. The system of claim 1 wherein the indicator light is a turn light.
